(19) United States
(12) Patent Application Publication
(10) Pub. No.: US 2022/0362948 A1
(43) Pub. Date: Nov. 17, 2022

(54) APPARATUS AND METHOD FOR MOUNTING O-RING AND ROBOT

(71) Applicant: ABB Schweiz AG, Baden (CH)

(72) Inventors: Qi Lu, Shanghai (CN); Zhiwei Li, Shanghai (CN)

(21) Appl. No.: 17/753,633

(22) PCT Filed: Sep. 25, 2019
(86) PCT No.: PCT/CN2019/107711

§ 371 Date: Mar. 9, 2022

(51) Int. Cl. B25J 15/10; B23P 19/08

(52) U.S. Cl. CPC B25J 15/10; B23P 19/084

(57) ABSTRACT

Embodiments of the present disclosure provide an apparatus and method for mounting an O-ring to a work piece. The apparatus comprises a guiding component comprising a frustum portion adapted to be arranged coaxially with a groove formed on an end surface of the work piece for receiving the O-ring, a large end face of the frustum portion arranged adjacent to the end surface; a plurality of through slots each extending a predetermined distance radially from an edge of the large end face; and a pressing component comprising a plurality of fingers each adapted to be fitted in and moved along the corresponding through slot to push the O-ring that is placed on the frustum portion into the groove, wherein a diameter of the large end face is larger than an inner diameter of the groove.

### FIELD

Embodiments of the present disclosure generally relate to a robot, and more specifically, to apparatuses and methods for mounting O-rings to a work piece.

### BACKGROUND

An O-ring, also known as a packing or a toric joint, is a mechanical gasket in the shape of a torus. It is a loop of elastomer with a round cross-section, designed to be seated in a groove and compressed during assembly between two or more parts, creating a seal at the interface. The O-ring may be used in static applications where there is no relative motion or in dynamic applications where there is relative motion between the parts and the O-ring.

O-rings are one kind of common seals used in machine design because they are inexpensive, easy to make and reliable. Under normal conditions, O-rings are assembled manually, which is inefficient and labor-intensive and significantly reduces the overall assembly efficiency of a work piece. In order to increase efficiency, the demand for automated assembly of O-rings is rising. The automated assembly of O-rings involves feeding and mounting of O-rings.

Traditional O-ring auto-assembly methods are usually merely suitable for the O-ring mounting on an outer circumference of a shaft or an inner circumference of a hole. However, such methods cannot be applied to mounting the O-ring, particularly the flexible O-ring, in a groove on an end surface of a work piece, which is also widely used in the industry. For example, some O-rings in the joints of a manipulator robot are mounted in the groove on the end surface.

### SUMMARY

To address or at least partially address the above and other potential problems, embodiments of the present disclosure provide an apparatus for mounting an O-ring to a work piece.

In a first aspect, an apparatus for mounting an O-ring to a work piece is provided. The apparatus comprises a guiding component comprising a frustum portion adapted to be arranged coaxially with a groove formed on an end surface of the work piece for receiving the O-ring; a large end face of the frustum portion arranged adjacent to the end surface; a plurality of through slots each extending a predetermined distance radially from an edge of the large end face; and a pressing component comprising a plurality of fingers each adapted to be fitted in and moved along the corresponding through slot to push the O-ring that is placed on the frustum portion into the groove, wherein a diameter of the large end face is larger than an inner diameter of the groove to allow the O-ring to be expanded at the large end face and to shrink to be received in the groove with pressing of the plurality of fingers.

With the apparatus comprising through slots formed on the frustum portion and fingers each fitted in and moved along the corresponding through slot, the O-ring which has a smaller diameter than or same as that of the groove for receiving it can be well received in the groove automatically without human intervention, increasing the degree of automation and thus the mounting efficiency and accuracy.

In some embodiments, the guiding component further comprises a diameter-reduced portion coaxially arranged at the large end face to allow the O-ring to shrink along the diameter-reduced portion to be received in the groove. With the diameter-reduced portion along which the O-ring can shrink, it can be ensured that the O-ring can be well received in the groove.

In some embodiments, a small-diameter end of the diameter-reduced portion at least partially contacts the work piece and has a diameter substantially larger than or equal to the inner diameter of the groove. In this way, the O-ring may be received in the groove after shrinking along the diameter-reduced portion, improving the reliability of the apparatus.

In some embodiments, the plurality of through slots are evenly arranged on the frustum portion. As a result, The O-ring is subjected to uniform pressure in the circumferential direction to prevent the O-ring from twisting or deflecting.

In some embodiments, the pressing component further comprises an operation ring, and wherein the plurality of fingers are evenly fixed to or integrally formed on one side of the operation ring in an axial direction. With this arrangement, the pressing component can be operated by an end effector of a robot more easily.

In some embodiments, a tip of each of the plurality of fingers closest to the axis is arranged on a circle centered on the axis, and a diameter of the circle is smaller than or same as the diameter of the large end face but larger than the inner diameter of the groove. As a result, the pressing component can press the O-ring until the O-ring is received in the groove.

In some embodiments, each of the plurality of fingers radially extends a predetermined distance inwardly from an inner circumference of the operation ring. In this way, the interference between the operation ring and the guiding component can be prevented, thereby improving the reliability of the apparatus.

In some embodiments, an end of each of the plurality of fingers away from the operation ring tapers radially outwardly toward the operation ring. This arrangement can facilitate the movement of the O-ring along the ends of the fingers when the fingers press the O-ring.

In some embodiments, the guiding component further comprises a gripped portion extending from a small end of the frustum portion. In this way, the guiding component can be picked up or moved by an end effector of a robot more easily.

In a second aspect, a robot is provided. The robot comprises an end effector adapted to operate the apparatus as mentioned according to the first aspect above to mount an O-ring to a work piece. In this way, the mounting of the O-ring on the end face of the work piece can be achieved with a robot, thereby improving efficiency and accuracy for mounting the O-ring.

In a third aspect, a method for mounting an O-ring to a work piece is provided. The method comprises placing a guiding component on an end surface of the work piece, with a frustum portion arranged coaxially with a groove formed on the end surface and a large end face of the frustum portion arranged adjacent to the end surface; placing the O-ring to surround the frustum portion; placing a pressing component with a plurality of fingers each being fitted in the corresponding through slot; and driving the pressing component to push the O-ring into the groove, wherein a diameter of the large end face is larger than an inner diameter of the groove to allow the O-ring to be expanded at the large end face and to shrink to be received in the groove with pressing of the plurality of fingers.

It is to be understood that the Summary is not intended to identify key or essential features of embodiments of the present disclosure, nor is it intended to be used to limit the scope of the present disclosure. Other features of the present disclosure will become easily comprehensible through the description below.

### BRIEF DESCRIPTION OF THE DRAWINGS

The above and other objectives, features and advantages of the present disclosure will become more apparent through more detailed depiction of example embodiments of the present disclosure in conjunction with the accompanying drawings, wherein in the example embodiments of the present disclosure, same reference numerals usually represent same components.

FIG. 1 shows a front view and a side view of an O-ring;

FIG. 2 shows a side view of an apparatus for mounting an O-ring to a work piece according to embodiments of the present disclosure;

FIG. 3 shows a perspective view of a guiding component and a work piece according to embodiments of the present disclosure;

FIG. 4 shows a perspective view of a guiding component with an O-ring and a work piece according to embodiments of the present disclosure;

FIG. 5 shows a perspective view of an apparatus for mounting an O-ring to a work piece according to embodiments of the present disclosure;

FIG. 6 shows a side view of an apparatus for mounting an O-ring to a work piece according to embodiments of the present disclosure; and

FIG. 7 shows a flowchart illustrating a method for mounting an O-ring to a work piece according to embodiments of the present disclosure.

Throughout the drawings, the same or similar reference symbols are used to indicate the same or similar elements.

### DETAILED DESCRIPTION

The present disclosure will now be discussed with reference to several example embodiments. It is to be understood these embodiments are discussed only for the purpose of enabling those skilled persons in the art to better understand and thus implement the present disclosure, rather than suggesting any limitations on the scope of the subject matter.

As used herein, the term “comprises” and its variants are to be read as open terms that mean “comprises, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be comprised below. A definition of a term is consistent throughout the description unless the context clearly indicates otherwise.

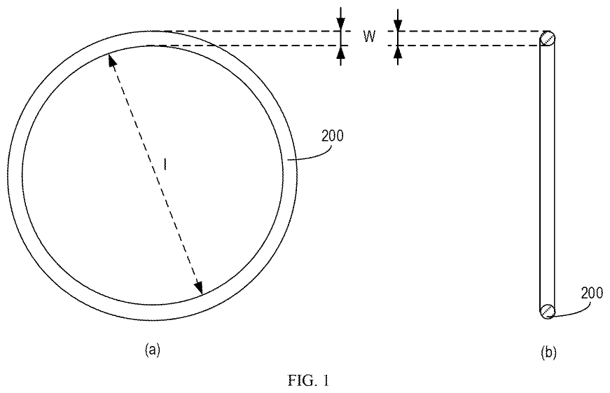

There are many sizes of O-rings used in the industry. FIG. 1 shows a front view and a side view of an O-ring 200. As shown, the O-ring 200 with certain elasticity has a wire diameter W and an inner diameter I. Generally, a ratio of the inner diameter I to the wire diameter W may reflect the deformation ability of the O-ring 200 to a certain extent. Specifically, the smaller the ratio, the harder to be deformed (refers to as “rigid O-ring”) and the larger the ratio, the more easily to be deformed (refers to as “flexible O-ring”).

Typically, to meet the requirements of the mating between different work pieces, an O-ring 200 can be mounted in a groove which is formed on an outer cylindrical surface, an inner cylindrical surface or an end surface of a work piece 300. Currently, there are solutions to allow the O-ring 200 to be mounted in the groove formed on the outer or inner cylindrical surface of a work piece 300 automatically, for example with a robot.

However, the O-ring 200 to be mounted in the groove formed on the end surface of the work piece 300 is typically a flexible O-ring, i.e., the ratio of the inner diameter I to the wire diameter W is large. In addition, some O-rings need to be deformed to be received in the groove on the end surface, i.e., a diameter of the O-ring is smaller than an inner diameter of the groove. In addition, if the O-ring or the end surface has to be greased as in many applications, the grease which has a certain viscosity may prevent the O-ring from being loaded into the corresponding groove. These conditions increase the difficulty to mount the O-ring 200 to the groove on the end surface automatically. For the above reasons, it is a challenge to automate the assembly of the O-ring 200 into the groove on the end surface. Nowadays, at least some steps of processes for mounting the O-ring 200 into the groove of the end surface requires human intervention, resulting in low efficiency and accuracy.

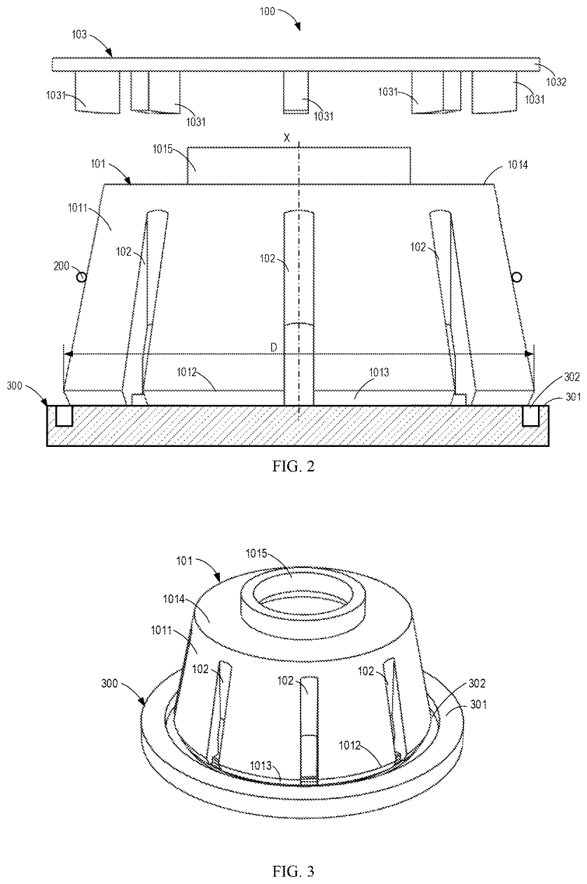

In order to improve efficiency and accuracy, embodiments of the present disclosure provide an apparatus 100 for mounting an O-ring 200 to a work piece 300. The apparatus 100 is particularly suitable for O-rings that require deformation to mount into the groove and, of course, for O-rings that can be mounted into the groove without deformation. Now some example embodiments will be described with reference to FIGS. 2-6.

FIG. 2 shows a perspective view of the apparatus 100 for mounting the O-ring 200 to the work piece 300. As shown, generally, the apparatus 100 comprises a guiding component 101 and a pressing component 103. On the one hand, the guiding component 101 is used to temporarily store the O-ring 200 to be received in a groove 302 formed on an end surface 301 of the work piece 300. On the other hand, the guiding component 101 is used to provide guidance for the O-ring 200 to slide along it.

The guiding component 101 comprises a frustum portion 1011 and a plurality of through slots 102 formed on the frustum portion 1011. The frustum portion 1011 can be placed on the end surface 301, for example by an end effector of a robot automatically, before the O-ring 200 needs to be mounted. After the guiding component 101 is placed on the end surface 301, the frustum portion 1011 is coaxial with the groove and has a large end face 1012 adjacent to the end surface 301.

It is to be understood that “adjacent to” herein means that the large end face 1012 may contact the end surface 301 in some embodiments. In some alternative embodiments, “adjacent to” also means that the large end face 1012 is closer to the end surface 301 than a small end face of the frustum portion 1011, and there may be structures, for example a diameter-reduced portion between the large end face 1012 and the end surface 301, which will be discussed further below.

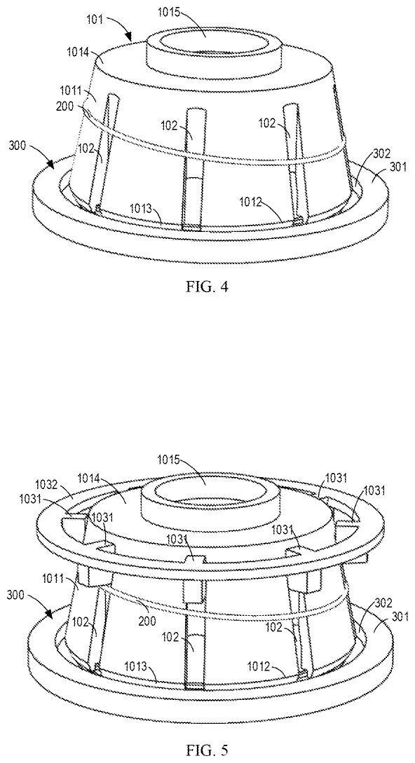

Each of the plurality of through slots 102 extends a predetermined distance radially from an edge of the large end face 1012, as shown in FIGS. 2 and 3. The predetermined distance causes the through slot 102 to extend a certain distance on a beveled surface of the frustum portion 1011, as shown in FIG. 2. After the O-ring 200 is dropped on the beveled surface of the frustum portion 1011, for example by the end effector of the robot automatically, the O-ring 200 lies in a portion of the beveled surface where the through slot 102 extends, as shown in FIG. 4. That is, the dropped O-ring 200 extends in a circumferential direction of the frustum portion 1011 across all the through slots 102.

One reason that the O-ring 200 lies on the frustum portion 1011 without falling directly onto the work piece 300 is that the inner diameter I of the O-ring 200 is smaller than a diameter D of the large end face 1012. To facilitate pressing the O-ring 200 to move along the frustum portion 1011, the pressing component 103 is needed. The pressing component 103 comprises a plurality of fingers 1031. Each finger 1031 can be fitted in and moved along the corresponding through slot 102, as shown in FIG. 5. In this way, the O-ring 200 that has been dropped on a groove-portion of the beveled surface can be pushed into the groove 302 along the beveled surface.

The diameter of the large end face 1012 is not only larger than the inner diameter I of the O-ring 200, but also larger than an inner diameter of the groove 302. In this way, when the O-ring 200 is moved to the large end face 1012, the O-ring 200 is expanded to have an expanded inner diameter same as that of the large end face 1012.

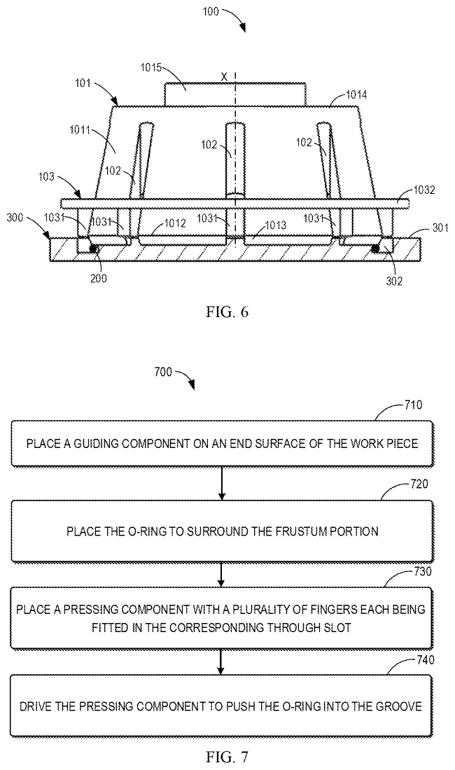

As the pressing component 103 continues to push, the O-ring 200 will pass over the large end face 1012. Since the large end face 1012 is adjacent to and coaxial with the groove 302, the O-ring 200 will shrink while entering the groove 302. In this way, the O-ring 200 is well received in the groove 302, as shown in FIG. 6.

In some embodiments, to facilitate coaxial arrangement between the groove 302 and the frustum portion 1011, the guiding component 101 may comprise an aligning portion (not shown) for aligning the guiding component 101 with the work piece 300. To this end, the aligning portion may be a portion that extends from the large end face 1012 along the axis X and may be inserted into an inner hole formed in the work piece 300. In this way, the guiding component 101 is aligned with the work piece 300, with the frustum portion 1011 coaxial with the groove 302.

It is to be understood that the above embodiment of aligning the guiding component 101 with the work piece 300 is merely for illustration, without suggesting any limitations as to the scope of the present disclosure. Any other suitable structures and/or arrangements are possible as well. For example, in some embodiments, the guiding component 101 may be aligned with the work piece 300 by inserting bumps formed on the large end face 1012 of the guiding component 101 into the corresponding slots formed on the end surface 301.

It can be seen from the above that the O-ring 200, the guiding component 101 and pressing component 103 all can be operated by a robot. Specifically, the guiding component 101 can be placed onto the work piece 300 by the robot. After that, the O-ring 200 to be mounted can be clamped or dropped onto the frustum portion 1011 by the robot. Then the pressing component 103 can be operated to press the O-ring 200 to mount the O-ring 200 into the groove 302 by the robot.

That is, with the apparatus 100 comprising through slots 102 formed on the frustum portion 1011 and fingers 1031 each fitted in and moved along the corresponding through slot 102, the O-ring 200 can be well received in the groove automatically without human intervention, increasing the degree of automation and thus the mounting efficiency and accuracy.

To reduce the uncertainty of the O-ring 200 suddenly shrinking from the large end face 1012 and entering the groove 302, in some embodiments, the guiding component 101 may further comprise a diameter-reduced portion 103 coaxially arranged at the large end face 1012, as shown in FIG. 2. The diameter-reduced portion 103 can provide guidance to the O-ring 200 shrinking from the large end face 1012.

It can be seen from FIG. 2, a diameter of the diameter-reduced portion 1013 gradually decreases from the large end face 1012. A large-diameter end of the diameter reduced portion 1013 is equal to that of the large end face 1012. This makes the angle between the beveled surface and the diameter-reduced portion 1013 an obtuse angle, as shown in FIG. 2, thereby reducing possible damage to the O-ring 200. In some embodiments, to further reduce the possible damage to the O-ring 200, the transition between the beveled surface and the diameter-reduced portion 1013 may be as smooth as possible. For example, in some embodiments, a fillet or a chamfer may be provided at the transition.

In some embodiments, a small-diameter end of the diameter-reduced portion 1013 may at least contact the end surface 301 of the work piece 300. For example, at least the region of the diameter-reduced portion 1013 adjacent to the groove 302 may contact the end surface 301. Furthermore, a diameter of the diameter-reduced portion 1013 may be substantially larger or equal to the inner diameter of the groove 302, which allows the O-ring 200 to shrink into the groove 302 smoothly.

Another factor that may affect the O-ring 200 entering the groove 300 is a distance between the large end face 1012 and an outer circumference of the groove 302. The distance between the large end face 1012 and an outer circumference of the groove 302 is selected to be larger than or equal to the wire diameter W of the O-ring 200. In this way, the O-ring 200 can smoothly pass over the large end face 1012 to be received in the groove 302.

In some embodiments, the plurality of through slots 102 are evenly arranged on the edge of the large end face 1012. Correspondingly, the fingers 1031 to be moved in the through slots 102 are evenly arranged as well. In this way, the O-ring 200 can be subjected to uniform pressure in the circumferential direction to prevent the O-ring 200 from twisting or deflecting, thereby causing the O-ring 200 to be mounted more stably.

Besides the plurality of through slots 102 being evenly arranged, the size of each through slot 102 is important as well. On the one hand, the sizes of the through slot 102 may be uniform. On the other hand, as mentioned above, as an aspect of sizes of the through slot 102, a depth of the each through slot 102, i.e., the predetermined distance the through slots extend radially, needs to be properly set. In this way, the O-ring 200 can be dropped on the region of the frustum portion 1011 with the through slots 102. Furthermore, besides the depth of the through slot 102, a width of the through slot 102 in a circumference direction also needs to be properly selected.

Specifically, if the width of the through slot 102 is too small, which results in a small width of the finger 1031, a pressure applied on the O-ring by each finger 1031 would be large. As a result, the O-ring 200 may be damaged during the process of being pressed by the fingers 1031 due to the large pressure applied thereon. In addition, if the width of the through slot 102 is too large, the O-ring 200 would be prone to twist during a process of being pressed by fingers 1031 each with a large width.

Accordingly, the width of the through slot 102 in the circumference direction needs to be properly selected to avoid damage or unnecessary deformation of the O-ring 200 when being pressed by the fingers 1031. Similarly, the number of the through slots 102 may also be properly selected. For example, the number of the through slots 102 or the fingers 1031 may range from 3-10 for greater stability.

In some embodiments, the number of the through slots 102 may be equal to that of the fingers 1031. Of course, it should be understood that those embodiments are merely for illustration, without suggesting any limitations as to the scope of the present disclosure. In some embodiments, the number of fingers 1031 may also be less than that of the through slots 102 as long as the position of each finger 1031 can be fitted in and moved along the position of the corresponding through slot 102.

To facilitate the operation of the robot, in some embodiments, the pressing component 103 may further comprise an operation ring 1032, as shown in FIGS. 2 and 5. The fingers 1031 may be evenly fixed to one side of the operation ring 1032 in an axial direction. In some alternative embodiments, the pressing component 103 may also be integrally formed by injection molding, extrusion or 3D printing. That is, the fingers 1031 may also be integrally formed on the operation ring 1032.

In some embodiments, the fingers 1031 may radially extend a predetermined distance inwardly from an inner circumference of the operation ring 1032. With this arrangement, interference between the operation ring 1032 and the frustum portion 1011 may be avoided.

To further avoid the possible interference between the operation ring 1032 and the frustum portion 1011, in some embodiments, an inner diameter of the operation ring 1032 may be selected to be larger than or substantially same as the diameter D of the large end face 1012.

In some embodiments, an innermost tip, i.e., a tip of each finger 1031 that is closest to the axis X is arranged on a circle centered on the axis X. Furthermore, to ensure that the O-ring 200 can be pushed by the fingers 1031 during the entire process of moving the fingers 1031 downwards, a diameter of the circle is smaller than or same as the diameter D of the large end face 1012. In addition, the diameter of the circle may be larger than the inner diameter of the groove 302. As a result, the ends of the fingers 1031 can pass over an upper surface of the work piece 300 and slightly enter the groove 302 in a vertical direction, to press the O-ring 200 to the bottom of the groove 302. In this way, the O-ring 200 can be well received in the groove 302.

It is to be understood that the above embodiments where the pressing component 103 may comprise the operation ring 1032 are merely for illustration, without suggesting any limitation as to the scope of the present disclosure. Other structures or arrangements are also possible. For example, in some alter embodiments, the operation ring 1032 may also be omitted and the fingers 1031 may be operated directly by the end effector of the robot.

As can be seen from FIG. 5, when the fingers 1031 press the O-ring 200, an end of the finger 1031 away from the operation ring 1032 contacts the O-ring 200. With the pressing of the fingers 1031, the O-ring 200 slides along the beveled surface of the frustum portion 1011 while sliding radially outward relative to the end of the finger 1031.

To ensure smooth movement of the O-ring 200 relative the end of the finger 1031, the end of the finger 1031 contacting the O-ring 200 may taper radially outwardly toward the operation ring 1032. That is, as the finger 1031 gradually extends outward, the end of the finger 1031 will gradually approach the operation ring 1032. This arrangement promotes the unavoidable sliding outward of the O-ring relative to the finger 1031. In some alternative embodiments, the end of the finger 1031 contacting the O-ring 200 may be a plane that is perpendicular to the axis X or have any other shapes.

To facilitate the operation of the robot to the guiding component 101, the guiding component 101 may further comprise a gripped portion 1015 extending from a small end 1014 of the frustum portion, as shown in FIGS. 2 and 3. The gripped portion 1015 allows the robot to grip more easily to further increase efficiency.

Besides a cylinder shape as shown in FIG. 3, the gripped portion 1015 may also have any suitable shapes for gripping. For example, in some embodiments, a cross section of the gripped portion 1015 may be of an oval shape, a square shape, a rectangular shape, a pentagon shape, a hexagon shape, or any other polygon shapes.

It can be seen from the above that the O-ring 200 can be picked up and can be well received in the groove 302 by the apparatuses 100 which is controlled by a robot automatically. That is, the entire operations of mounting the O-ring 200 in the groove 302 can be achieved by the robot being programmed without human intervention, thereby improving the efficiency and accuracy.

Embodiments of the present disclosure further provide a robot as mentioned above. The robot comprises an end effector that can operate the apparatus 100 as mentioned above to mount the O-ring 200 to a work piece 300. In this way, the O-ring 200 can be mounted into the groove 302 formed on an end surface 301 of the work piece 300 in an automated manner without human intervention, thereby improving the efficiency and accuracy. In some embodiments, as mentioned above, the operation component 102 of the apparatus 100 may be operated by the end effector or may be a part of the end effector.

Embodiments of the present disclosure further provide a method for mounting an O-ring 200 to a work piece 300. FIG. 7 shows a flowchart 700 illustrating the method. As shown, in block 710, a guiding component 101 is placed on an end surface 301 of the work piece 300, for example by the operation component 102. The guiding component 101 has a frustum portion 1011 arranged coaxially with a groove 302 formed on the end surface 301 and a large end face 1012 of the frustum portion 1011 arranged adjacent to the end surface.

In block 720, an O-ring 200 is placed to surround the frustum portion 1011. After that, in block 730, the pressing component 103 with a plurality of fingers 1031 each being fitted in the corresponding through slot 102 is placed. In block 740, the pressing component 103 is driven to push the O-ring 200 into the groove 302, wherein a diameter D of the large end face 1012 is larger than an inner diameter of the groove 302 to allow the O-ring 200 to be expanded at the large end face 1012 and to shrink to be received in the groove 302 with pressing of the plurality of fingers.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be comprised in the scope of protection of the present disclosure. Meanwhile, appended claims of the present disclosure aim to cover all the variations and modifications falling under the scope and boundary of the claims or equivalents of the scope and boundary.

1. An apparatus for mounting an O-ring to a work piece, comprising:
a guiding component comprising a frustum portion adapted to be arranged coaxially with a groove formed on an end surface of the work piece for receiving the O-ring, a large end face of the frustum portion arranged adjacent to the end surface;
a plurality of through slots each extending a predetermined distance radially from an edge of the large end face; and
a pressing component comprising a plurality of fingers each adapted to be fitted in and moved along the corresponding through slot to push the O-ring that is placed on the frustum portion into the groove,
wherein a diameter (D) of the large end face is larger than an inner diameter of the groove to allow the O-ring to be expanded at the large end face and to shrink to be received in the groove with pressing of the plurality of fingers.

2. The apparatus of claim 1, wherein the guiding component further comprises a diameter-reduced portion coaxially arranged at the large end face to allow the O-ring to shrink along the diameter-reduced portion to be received in the groove.

3. The apparatus of claim 2, wherein a small-diameter end of the diameter-reduced portion at least partially contacts the end surface of the work piece and has a diameter substantially larger than or equal to the inner diameter of the groove.

4. The apparatus of claim 1, wherein the plurality of through slots are evenly arranged on the frustum portion.

5. The apparatus of claim 1, wherein the pressing component further comprises an operation ring, and
wherein the plurality of fingers are evenly fixed to or integrally formed on one side of the operation ring in an axial direction.

6. The apparatus of claim 1, wherein a tip of each of the plurality of fingers closest to the axis (X) is arranged on a circle centered on the axis (X), and
a diameter of the circle is smaller than or same as the diameter (D) of the large end face but larger than the inner diameter of the groove.

7. The apparatus of claim 5, wherein each of the plurality of fingers radially extends a predetermined distance inwardly from an inner circumference of the operation ring.

8. The apparatus of claim 5, wherein an end of each of the plurality of fingers away from the operation ring tapers radially outwardly toward the operation ring.

9. The apparatus of claim 1, wherein the guiding component further comprises a gripped portion extending from a small end of the frustum portion.

10. A robot comprising;
an end effector adapted to operate the apparatus according to claim 1 to mount an O-ring to a work piece.

11. A method for mounting an O-ring to a work piece, comprising:
placing a guiding component on an end surface of the work piece, with a frustum portion arranged coaxially with a groove formed on the end surface and a large end face of the frustum portion arranged adjacent to the end surface;
placing the O-ring to surround the frustum portion;
placing a pressing component with a plurality of fingers each being fitted in the corresponding through slot; and
driving the pressing component to push the O-ring into the groove, wherein a diameter (D) of the large end face is larger than an inner diameter of the groove to allow the O-ring to be expanded at the large end face and to shrink to be received in the groove with pressing of the plurality of fingers.

12. A robot comprising:
an end effector adapted to operate the apparatus according to claim 2 to mount an O-ring to a work piece.

13. A robot comprising:
an end effector adapted to operate the apparatus according to claim 3 to mount an O-ring to a work piece.

14. A robot comprising:
an end effector adapted to operate the apparatus according to claim 4 to mount an O-ring to a work piece.

15. A robot comprising:
an end effector adapted to operate the apparatus according to claim 5 to mount an O-ring to a work piece.

16. A robot comprising:
an end effector adapted to operate the apparatus according to claim 6 to mount an O-ring to a work piece.

17. A robot comprising:
an end effector adapted to operate the apparatus according to claim 7 to mount an O-ring to a work piece.

18. A robot comprising:
an end effector adapted to operate the apparatus according to claim 8 to mount an O-ring to a work piece.

19. A robot comprising:
an end effector adapted to operate the apparatus according to claim 9 to mount an O-ring to a work piece.
